(19) United States
(12) Patent Application Publication
(10) Pub. No.: US 2026/0369497 A1
(43) Pub. Date: Nov. 19, 2026

(54) HOUSING AND RELAY

(71) Applicant: Xiamen Hongfa Electric Power Controls Co., Ltd., Xiamen, Fujian (CN)

(72) Inventors: Wenguang DAI, Xiamen, Fujian (CN); Dapeng FU, Xiamen, Fujian (CN); Songsheng CHEN, Xiamen, Fujian (CN)

(73) Assignee: Xiamen Hongfa Electric Power Controls Co., Ltd., Xiamen, Fujian (CN)

(21) Appl. No.: 19/121,082

(22) PCT Filed: Oct. 11, 2023
(86) PCT No.: PCT/CN2023/124044

§ 371 Date: Apr. 17, 2025

(30) Foreign Application Priority Data
Oct. 12, 2022 (CN) 202222685474.7

(51) Int. Cl. H01H 50/02

(52) U.S. Cl. CPC H01H 50/02

(57) ABSTRACT

Provided are a shell and a relay, which relate to the technical field of power devices. The shell comprises a first shell (1) and a second shell (2), the second shell (2) is arranged directly opposite the first shell (1), and the first shell and the second shell are connected to each other; one of the first shell (1) and the second shell (2) is provided with a buckle (11) and a flexible deformation portion (12), and the other is provided with a clamping portion (21); and the buckle (11) is configured to selectively clamp onto the clamping portion (21), wherein the flexible deformation portion (12) at least partially wraps and is annularly arranged around the buckle (11) and is used for the flexible deformation of the buckle (11). The flexible deformation portion (12) increases the flexibility of the buckle (11) to form an elastic buckle structure, so that the buckle (11) is easy to deform during the process of matching between the first shell (1) and the second shell (2), thereby reducing the stress of the first shell (1) and the second shell (2) at a weak clamping position.

### CROSS-REFERENCE

The present disclosure claims priority to Chinese Patent Application No. 202222685474.7, filed on Oct. 12, 2022 and titled “Housing and Relay,” the entire content of which is incorporated herein by reference in its entirety.

### TECHNICAL FIELD

The present disclosure relates to a housing and a relay.

### BACKGROUND

A relay is an electrically controlled element that that causes a predetermined step change in a controlled quantity in an electrical output circuit when a change in an input quantity meets a specified requirement.

A housing of the relay plays a role in mounting and protecting internal components. Due to the need for protection on all six sides of the housing, it cannot be made into an integrated structure. Instead, the housing is generally made into a split structure with two parts, and the two parts are fixed by snaps or other fastening methods. However, the snap structure is relatively weak in a snap position, which is prone to cracking during assembly and affects the overall reliability of the relay.

### SUMMARY

The present disclosure provides a housing and a relay that may reduce the risk of cracking and improve the structural stability.

According to one aspect of the present disclosure, there is provided a housing, including a first housing; and a second housing disposed corresponding to and connected to the first housing. One of the first housing and the second housing is provided with a snap and a flexible deformation portion, and the other thereof is provided with an engaging portion. The snap is configured to be selectively engaged with the engaging portion. The flexible deformation portion at least partially surrounds the snap for flexible deformation of the snap.

According to an embodiment of the present disclosure, the flexible deformation portion is a through-hole with an open at an end, and the end with the open of the through-hole is oriented towards the snap.

According to an embodiment of the present disclosure, a cross-section of the through-hole is any one of U-shape, C-shape, and V-shape.

According to an embodiment of the present disclosure, the snap includes an extension arm and a snap head, one end of the extension arm is connected to one of the first housing and the second housing, and another end of the extension arm is provided with the snap head, the snap head being selectively engaged with the engaging portion. The flexible deformation portion is annularly disposed around the extension arm.

According to an embodiment of the present disclosure, the engaging portion is an engaging groove or an engaging hole.

According to an embodiment of the present disclosure, there are a plurality of snaps, flexible deformation portions, and engaging portions; the plurality of snaps are disposed around the first housing; the plurality of snaps are correspondingly engaged with the plurality of engaging portions; and the plurality of flexible deformation portions are disposed corresponding to the plurality of snaps.

According to an embodiment of the present disclosure, the housing further includes a protective portion connected to one of the first housing and the second housing and surrounding at least a part of the snap.

According to an embodiment of the present disclosure, the protective portion is of a rib structure.

According to an embodiment of the present disclosure, the protective portion is of a U-shaped structure, and an end with the open of the U-shaped structure is oriented towards the snap.

According to an embodiment of the present disclosure, a chamfer is provided at a corner position of the protective portion.

According to an embodiment of the present disclosure, a gap is provided between the protective portion and the snap, and the gap forms at least a part of the flexible deformation portion.

According to an embodiment of the present disclosure, at least one of the first housing and the second housing includes a side plate that is provided with a plurality of snaps; two ends of the protective portion are connected to the side plate; and the protective portion surrounds the plurality of snaps.

According to a second aspect of the present disclosure, embodiments of the present disclosure also provide a relay including the above housing.

One embodiment of the present disclosure has at least the following advantages or beneficial effects.

For the housing according to the present disclosure, the first housing and the second housing are of a split structure, and the first housing and the second housing are disposed corresponding to each other and connected to each other, so that the first housing and the second housing form an accommodation space for and protect internal components of a relay. One of the first housing and the second housing is provided with the snap, and the other thereof is provided with the engaging portion. The snap is configured to be engaged with the engaging portion, achieving fixation of the first housing and the second housing. The snap is configured to be selectively engaged with the engaging portion, facilitating the assembly and detachment between the first housing and the second housing. The flexible deformation portion at least partially surrounds the snap, and improves the flexibility of the snap, forming an elastic snap structure, which makes it easy for the snap to deform during a fitting process of the first housing and the second housing, reduces stress at the weak engaging position between the first housing and the second housing, and reduces the risk of cracking. The flexible deformation portion at least partially surrounds the snap, increasing a coverage area of the flexible deformation portion on the snap to maximize a flexibility effect of the snap.

For the relay according to the present disclosure, the first housing and the second housing of the housing are of a split structure, and the first housing and the second housing are disposed corresponding to each other and connected to each other, so that the first housing and the second housing form an accommodation space for and protect internal components of a relay. One of the first housing and the second housing is provided with the snap, and the other thereof is provided with the engaging portion. The snap is configured to be engaged with the engaging portion, achieving fixation of the first housing and the second housing. The snap is configured to be selectively engaged with the engaging portion, facilitating the assembly and detachment between the first housing and the second housing. The flexible deformation portion at least partially surrounds the snap, and improves the flexibility of the snap, forming an elastic snap structure, which makes it easy for the snap to deform during a fitting process of the first housing and the second housing, reduces stress at the weak engaging position between the first housing and the second housing, and reduces the risk of cracking. The flexible deformation portion at least partially surrounds the snap, increasing a coverage area of the flexible deformation portion on the snap to maximize a flexibility effect of the snap.

### BRIEF DESCRIPTION OF THE DRAWINGS

The above and other features and advantages of the present disclosure will become more apparent by describing in detail exemplary embodiments with reference to the accompanying drawings.

FIG. 1 shows a schematic view of a housing according to an embodiment of the present disclosure;

FIG. 2 shows an exploded view of a housing according to an embodiment of the present disclosure;

FIG. 3 shows a partial sectional view of a housing according to an embodiment of the present disclosure;

FIG. 4 shows a partial enlarged view of part A in FIG. 3;

FIG. 5 shows a schematic view of a snap and a flexible deformation portion of a housing according to an embodiment of the present disclosure.

Reference numerals:

1. first housing; 2. second housing; 3. protective portion; 11. snap; 111. extension arm; 112. snap head; 12. flexible deformation portion; 13. connecting portion; 14. side plate; 15. notch; 16. gap; 21. engaging portion.

### DETAILED DESCRIPTION

Exemplary embodiments will be now described more fully with reference to the accompanying drawings. However, the exemplary embodiments may be embodied in a variety of forms and should not be construed as being limited to the embodiments set forth herein. Although relative terms such as “above” and “under” are used herein to describe the relationship of one component relative to another component, such terms are used herein only for the sake of convenience, for example, in the directions shown in the figures. It can be understood that if the referenced device is inversed upside down, a component described as “above” will become a component described as “under”. Other relative terms such as “top” and “bottom” also have similar meanings. When a structure is described as “above” another structure, it probably means that the structure is integrally formed on another structure, or the structure is “directly” disposed on another structure, or the structure is “indirectly” disposed on another structure through an additional structure.

Words “one,” “a/an,” “the” and “said” are used herein to indicate the presence of one or more elements/component parts/and others. Terms “including” and “having” have an inclusive meaning which means that there may be additional elements/component parts/and others in addition to the listed elements/component parts/and others. Terms such as “first” and “second” are used herein only as markers and do not limit the number of objects modified after them.

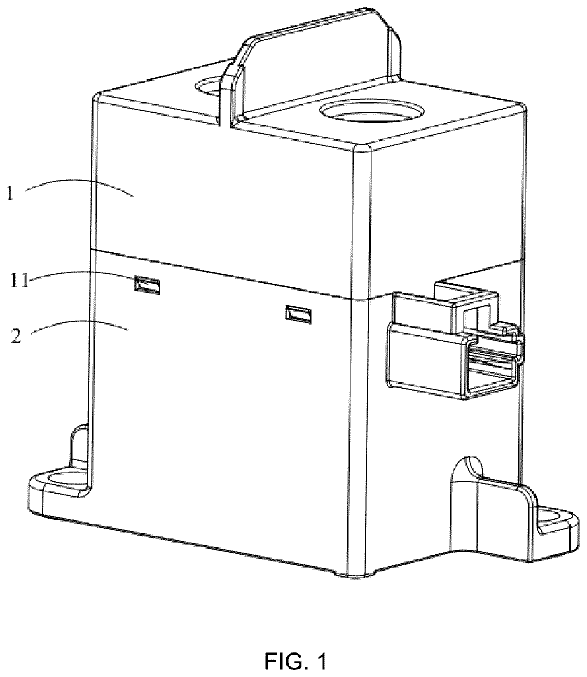

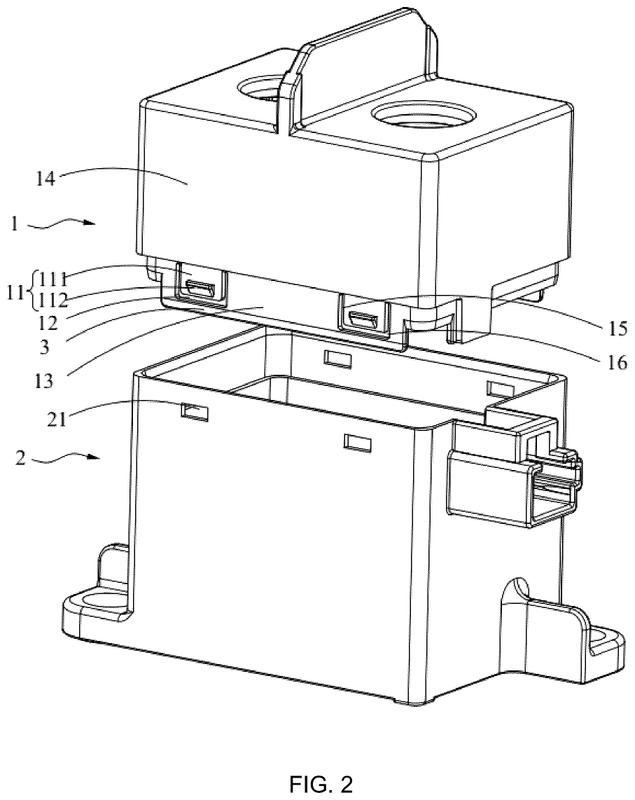

Embodiments of the present disclosure provide a housing. As shown in FIGS. 1-2, the housing includes a first housing 1 and a second housing 2. The second housing 2 is disposed corresponding to the first housing 1 and is connected to the first housing 1. One of the first housing 1 and the second housing 2 is provided with a snap 11, and the other thereof is provided with an engaging portion 21. The snap 11 is configured to be selectively engaged with the engaging portion 21. The first housing 1 and the second housing 2 may also be called an upper housing and a lower housing.

For the housing according to embodiments of the present disclosure, the first housing 1 and the second housing 2 are of a split structure, and the first housing 1 and the second housing 2 are disposed corresponding to each other and connected to each other, so that the first housing 1 and the second housing 2 form an accommodation space for and protect internal components of a relay. One of the first housing 1 and the second housing 2 is provided with the snap 11, and the other thereof is provided with the engaging portion 21. The snap 11 is engaged with the engaging portion 21, achieving fixation of the first housing 1 and the second housing 2. Due to the selective engagement of the snap 11 with the engaging portion 21, the assembly and detachment between the first housing 1 and the second housing 2 may be facilitated.

If the first housing 1 and the second housing 2 are relatively weak at a docking position between the snap 11 and the engaging portion 21, cracking may easily occur during an assembly process. Thus, for the housing according to embodiments of the present disclosure, one of the first housing 1 and the second housing 2, which includes the snap 11, is provided with a flexible deformation portion 12, and the flexible deformation portion 12 at least partially surrounds around the snap 11 for flexible deformation of the snap 11.

For the housing according to embodiments of the present disclosure, the flexible deformation portion 12 at least partially surrounds the snap 11, and improves the flexibility of the snap 11, forming an elastic snap structure, which makes it easy for the snap 11 to deform during a fitting process of the first housing and the second housing, reduces stress at the weak engaging position between the first housing 1 and the second housing 2, and reduces the risk of cracking. The flexible deformation portion 12 at least partially surrounds the snap 11, increasing a coverage area of the flexible deformation portion 12 on the snap 11 to maximize a flexibility effect of the snap 11.

It should be noted that the engaging portion 21 is an engaging groove or an engaging hole. Specifically, the engaging portion 21 may be an engaging groove recessed in an inner wall of the first housing 1 or the second housing 2 in a direction away from the snap 11. The snap 11 at least partially extends into the engaging groove and abuts against a groove wall of the engaging groove. The engaging portion 21 may also be an engaging hole that is a through-hole structure, and the snap 11 at least partially extends into the engaging hole and abuts against an inner wall of the engaging hole. The embodiments of the present disclosure do not limit the specific form of the engaging portion 21, as long as it may provide an engaging fitting position for the snap 11, which also falls into the protection scope of the embodiments of the present disclosure.

It can be understood that the engaging hole may be a rectangular hole or other shape hole structure, and its specific shape may be adjusted according to actual production situations.

In one embodiment, the flexible deformation portion 12 is a through-hole with an open at one end, and the end with the open of the through-hole is oriented towards the snap 11.

The flexible deformation portion 12 configured as the through-hole is equivalent to that flexible deformation of the snap 11 may be achieved by directly providing the through-hole in the first housing 1 and the second housing 2. The structure is simple, the processing technique is simplified, and the production cost is lowered. If the through-hole is an annular structure, the through-hole surrounds the snap 11, and under the action of the through-hole, it is equivalent to cutting the snap 11 directly from the first housing 1 or the second housing 2 by the through-hole, so that the snap 11 lacks a fixing position. For this reason, by making the end with the open of the through-hole oriented towards the snap 11, the open structure at one end of the through-hole may avoid influence of an annular closed structure of the through-hole on the fixing position of the snap 11, and at this time, the through-hole may play a flexible deformation role for the snap 11 without affecting the positional stability of the snap 11.

It should be noted that for the flexible deformation portion 12 configured as the through-hole with one open at one end, the through-hole is essentially a slit structure, and the slit has a relatively narrow width and may achieve flexible deformation of the snap 11; at the same time, the slit partially surrounds the snap 11, i.e., a semi-surrounding structure, which may avoid unstable fixing position of the snap 11.

In one embodiment, a cross-section of the through-hole is any one of U-shape, C-shape, and V-shape.

By providing the “U-shaped,” “C-shaped,” or “V-shaped” through-hole around the position of the snap 11, the through-hole forms an accommodation space for accommodating the snap 11. It can be understood that an opening position of the through-hole is a connection position between the snap 11 and the first housing 1 or the second housing 2.

It should be noted that the through-hole is not limited to regular structures such as U-shape, C-shape, and V-shape, and may also be of other irregular structures, as long as it has the opening, which falls into the protection scope of the embodiments of the present disclosure.

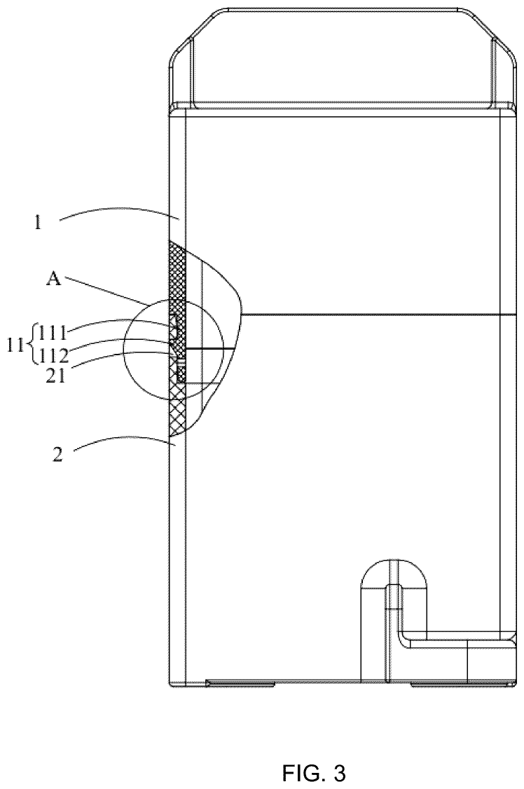

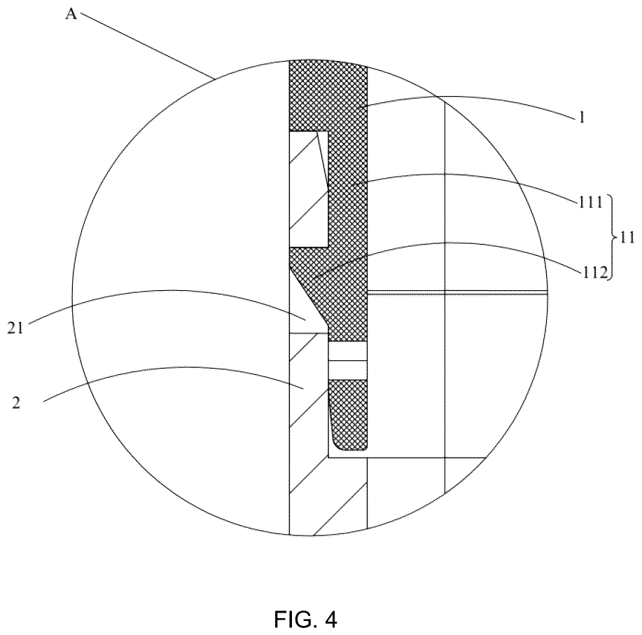

In one embodiment, as shown in FIGS. 2-4, the snap 11 includes an extension arm 111 and a snap head 112. One end of the extension arm 111 is connected to one of the first housing 1 and the second housing 2, and the other end of the extension arm 111 is provided with the snap head 112, which is selectively engaged with the engaging portion 21. The flexible deformation portion 12 surrounds the extension arm 111.

The extension arm 111 serves as an intermediate connection between the housing and the snap head 112. The extension arm 111 extends along an edge of the first housing 1 or the second housing 2 to form an extension end, allowing the snap head 112 to approach the engaging portion 21 and facilitate the connection between the snap head 112 and the engaging portion 21. The snap head 112 of the snap 11 is at a position essentially connected to the engaging portion 21, and the extension arm 111 of the snap 11 essentially provides a fixing position for the snap head 112. The flexible deformation portion 12 is annularly disposed around the extension arm 111, so that a free end of the extension arm 111 may move relative to the first housing 1 or the second housing 2 and hence has a certain amount of elastic deformation, providing flexibility for the mutual engagement between the snap head 112 and the engaging portion 21, and avoiding tearing during a docking process of the snap head 112 and the engaging portion 21.

In one embodiment, there are a plurality of snaps 11, flexible deformation portions 12, and engaging portions 21, with the plurality of snaps 11 correspondingly engaged with the plurality of engaging portions 21, and the plurality of flexible deformation portions 12 disposed corresponding to the plurality of snaps 11.

When the first housing 1 and the second housing 2 are connected, the plurality of flexible deformation portions 12 are disposed corresponding to the plurality of snaps 11, so that there are a plurality of connection positions between the first housing 1 and the second housing 2, and an effect of fixation between the first housing 1 and the second housing 2 is improved.

The plurality of snaps 11 are annularly disposed around the first housing 1, so that the first housing 1 may be well fixed along its circumferential direction, and the entire structure is well-balanced. The plurality of flexible deformation portions 12 are disposed corresponding to the plurality of snaps 11, so that each snap 11 may correspond to the flexible deformation portion 12, ensuring the flexible deformation amount of each snap 11.

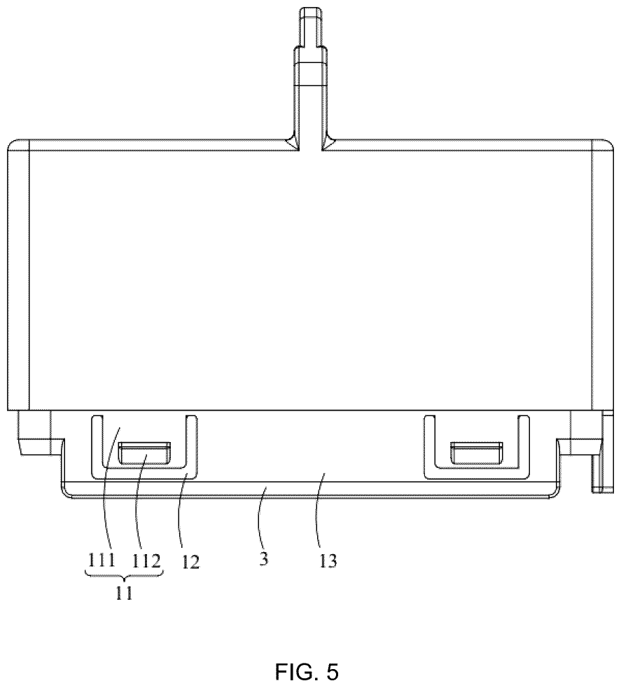

In one embodiment, as shown in FIGS. 2 and 5, the housing further includes a protective portion 3, which is connected to one of the first housing 1 and the second housing 2 and surrounds at least a part of the snap 11.

The first housing 1 or the second housing 2 provides a mounting position for the protective portion 3, and at least a part of the snap 11 is surrounded by the protective portion 3, which is equivalent to the protective portion 3 being annularly disposed around the snap 11. The protective portion 3 plays a role in protecting the snap 11, avoiding the snap 11 from being bumped during transportation or circulation, and achieving a purpose of extending the service life of the snap 11.

In one embodiment, the protective portion 3 is a rib structure. The protective portion 33 that adopts the rib structure is simple in structure and has relatively low production cost.

If the protective portion 3 has a right-angle structure at a corner position, the corner position of the protective portion 3 is relatively sharp and prone to scratches. Thus, a chamfer is provided at the corner position of the protective portion 3, that is, the corner of the protective portion 3 has a relatively smooth structure, which serves to provide rounded transition and reduces a risk of hard contact scratches.

In one embodiment, the protective portion 3 is of a U-shaped structure, and an internal space of the protective portion 3 provides an accommodation space for the snap 11. A side wall of the protective portion 3 plays a role in providing external protection for the snap 11, and the end with the open of the U-shaped structure is oriented towards the snap 11. Using the open of the U-shaped structure, it is convenient to place the snap 11 into an interior of the protective portion 3.

It should be noted that the protective portion 3 of the U-shaped structure is equivalent to a half of a rectangular ring, that is, the rectangular ring is cut along its lengthwise central axis to obtain two half ring structures. The half ring structure is the protective portion 3 of the U-shaped structure, which may achieve surrounding of at least a part of the snap 11.

In one embodiment, at least one of the first housing 1 and the second housing 2 includes a side plate 14, and the side plate 14 is provided with a plurality of snaps 11. Two ends of the protective portion 3 are connected to the side plate 14, and the protective portion 3 surrounds the plurality of snaps 11.

For each side plate 14, the plurality of snaps 11 are mounted on each side plate 14 to ensure an effect of fixing each side plate 14. For the surrounding of the protective portion 3 around the plurality of snaps 11, the protective portion 3 may simultaneously surround snaps 11 at two positions.

For example, two snaps 11 are disposed on the side plate 14 and located at both ends of the side plate 14 along an extension direction of the side plate 14. At this time, there is a connecting portion 13 extending from an edge of the side plate 14 close to the snaps 11, and the connecting portion 13 is disposed between the two snaps 11 and serves as an intermediate connection. It can be understood that the two ends of the protective portion 3 are connected to the two ends of the side plate 14 and located outside the two snaps 11, and the middle of the protective portion 3 is connected to the connecting portion 13, ensuring the stability of connection between the protective portion 3 and the side plate 14.

Since the through-hole at least partially surrounds the snap 11, and the protective portion 3 surrounds at least a part of the snap 11, in order to prevent interference between the through-hole and the position of the protective portion 3, a gap 16 is provided between the protective portion 3 and the snap 11, and the gap 16 forms at least a part of the flexible deformation portion 12.

Along a height direction of the first housing 1, respective sides of the protective portion 3 and the snap 11, which are close to each other, are not in contact with each other, but have a certain gap 16 therebetween, so that the protective portion 3 is staggered from the snap 11, and at this time, the gap 16 forms a bottom space of the U-shaped through-hole. Along an extension direction of the first housing 1, respective sides of the protective portion 3 and the snap 11, which are close to each other, are not in contact with each other, but have a certain gap 16 therebetween, so that the protective portion 3 is staggered from the snap 11, and at this time, the gap 16 forms one side wall space of the U-shaped through-hole. Along the extension direction of the first housing 1, respective sides of the protective portion 3 and the snap 11, which are close to each other, are not in contact with each other, but have a certain gap 16 therebetween, so that the protective portion 3 is staggered from the snap 11, and at this time, the gap 16 forms another side wall space of the U-shaped through-hole.

It can be understood that the protective portion 3 and the side plate 14 may be of an integrally formed structure, and the protective portion 3 and the side plate 14 may also be of a split structure. When the protective portion 3 and the side plate 14 are of an integrally formed structure, a through-hole may be provided at a lower end of the side plate 14 and around the snap 11, and a part of the side plate 14 located at a lower end of the through-hole is the protective portion 3. When the protective portion 3 and the side plate 14 are of a split structure, the snap 11 is machined on the side plate 14, and a notch 15 is provided between the snap 11 and the connecting portion 13 and is a strip-shaped structure, in which case the protective portion 3 simultaneously surrounds the two snaps 11, and respective sides of the protective portion 3 and the snap 11, which are close to each other, are not in contact with each other, but have a certain gap 16 therebetween; the gap 16 may be a J-shaped or L-shaped structure, and the gap 16 and the notch 15 together form the U-shaped through-hole.

Another aspect of the present disclosure provides a relay including the above housing.

For the housing according to the present disclosure, the first housing 1 and the second housing 2 are of a split structure, and the first housing 1 and the second housing 2 are disposed corresponding to each other and connected to each other, so that the first housing 1 and the second housing 2 form an accommodation space for and protect internal components of the relay. One of the first housing 1 and the second housing 2 is provided with the snap 11, and the other thereof is provided with the engaging portion 21. The snap 11 is engaged with the engaging portion 21, achieving fixation of the first housing 1 and the second housing 2. Due to the selective engagement of the snap 11 with the engaging portion 21, the assembly and detachment between the first housing 1 and the second housing 2 may be facilitated.

The flexible deformation portion 12 at least partially surrounds the snap 11, and improves the flexibility of the snap 11, forming an elastic snap structure, which makes it easy for the snap 11 to deform during a fitting process of the first housing and the second housing, reduces stress at the weak engaging position between the first housing 1 and the second housing 2, and reduces the risk of cracking. The flexible deformation portion 12 at least partially surrounds the snap 11, increasing a coverage area of the flexible deformation portion 12 on the snap 11 to maximize a flexibility effect of the snap 11.

It can be understood that the housing is mainly used to accommodate internal components of the relay, such as an electromagnetic unit, a movable contact, and a static contact.

It should be understood that the application of the present disclosure is not limit to the detailed structure and arrangement of components provided in this specification. The present disclosure may have other embodiments, and may be implemented and carried out in various ways. The aforementioned variations and modifications fall within the scope of the present disclosure. It should be understood that the present disclosure revealed and defined in this specification may extend to all alternative combinations of two or more individual features that are apparent or mentioned in the text and/or drawings. All of the different combinations form various alternative aspects of the present disclosure. Embodiments described in this specification illustrate the best modes known for carrying out the present disclosure, and will allow those skilled in the art to utilize the present disclosure.

What is claimed is:

1. A housing, comprising:
a first housing (1); and
a second housing (2) disposed corresponding to and connected to the first housing (1), one of the first housing (1) and the second housing (2) being provided with a snap (11) and a flexible deformation portion (12), and another of the first housing (1) and the second housing (2) being provided with an engaging portion (21), the snap (11) being configured to be selectively engaged with the engaging portion (21),
wherein the flexible deformation portion (12) at least partially surrounds the snap (11) for flexible deformation of the snap (11).

2. The housing according to claim 1, wherein the flexible deformation portion (12) is a through-hole with an open at an end, and the end with the open of the through-hole is oriented towards the snap (11).

3. The housing according to claim 2, wherein a cross-section of the through-hole is any one of U-shape, C-shape, and V-shape.

4. The housing according to claim 1, wherein the snap (11) comprises an extension arm (111) and a snap head (112), one end of the extension arm (111) is connected to one of the first housing (1) and the second housing (2), and another end of the extension arm (111) is provided with the snap head (112), the snap head (112) being selectively engaged with the engaging portion (21);
wherein the flexible deformation portion (12) is annularly disposed around the extension arm (111).

5. The housing according to claim 1, wherein the engaging portion (21) is an engaging groove or an engaging hole.

6. The housing according to claim 1, wherein there are a plurality of snaps (11), a plurality of flexible deformation portions (12), and a plurality of engaging portions (21); the plurality of snaps (11) are disposed around the first housing (1); the plurality of snaps (11) are correspondingly engaged with the plurality of engaging portions (21); and the plurality of flexible deformation portions (12) are disposed corresponding to the plurality of snaps (11).

7. The housing according to any one of claims 1 to 6, further comprising a protective portion (3) connected to one of the first housing (1) and the second housing (2) and surrounding at least a part of the snap (11).

8. The housing according to claim 7, wherein the protective portion (3) is of a rib structure.

9. The housing according to claim 7, wherein the protective portion (3) is of a U-shaped structure, and an end with the open of the U-shaped structure is oriented towards the snap (11).

10. The housing according to claim 7, wherein a chamfer is provided at a corner position of the protective portion (3).

11. The housing according to claim 7, wherein a gap is provided between the protective portion (3) and the snap (11), and the gap forms at least a part of the flexible deformation portion (12).

12. The housing according to claim 7, wherein at least one of the first housing (1) and the second housing (2) comprises a side plate (14) that is provided with a plurality of snaps (11); two ends of the protective portion (3) are connected to the side plate (14); and the protective portion (3) surrounds the plurality of snaps (11).

13. A relay, comprising the housing according to any one of claims 1 to 12.
